(19) United States
(12) Patent Application Publication
(10) Pub. No.: US 2008/0172610 A1
(43) Pub. Date: Jul. 17, 2008

(54) Customizable User Interface For Electronic Devices

(76) Inventor: Paul Blair, La Jolla, CA (US)

Correspondence Address: FISH & RICHARDSON, PC, P.O. BOX 1022, MINNEAPOLIS, MN, 55440-1022, US

(21) Appl. No.: 11/908,284

(22) PCT Filed: Mar. 13, 2006
(86) PCT No.: PCT/US06/09098

§ 371 Date: Nov. 30, 2007

Related U.S. Application Data
(60) Provisional application No. 60/660,787, filed on Mar. 11, 2005.

(51) Int. Cl. G06F 3/00

(52) U.S. Cl. 715/700

(57) ABSTRACT

Techniques and devices (110, 310, 350) for providing a customized user interface for a programmable electronic device (101, 330, 340) originally equipped with a user interface different from the customized user interface. The operation of programmable electronic devices such as mobile phone (101) and game consoles (330, 340) can be adapted to user preferences and to persons with disabilities.

This application claims the benefit of U.S. Provisional Application No. 60/660,787 entitled “CUSTOMIZABLE USER INTERFACE FOR ELECTRONIC DEVICES” and filed Mar. 11, 2006, which is incorporated by reference as part of the specification of this application.

### BACKGROUND

This application relates to user control over electronic devices for various applications, including consumer electronic devices.

Electronic devices for communications, data processing, entertainment and other applications have become an increasingly important part of daily activities and routines for the general population. Examples of such electronic devices include, mobile, wireless devices such as cell phones and personal digital assistant (PDA) devices, electronic game consoles, video devices such as DVD players, and audio players such as CD and MP3 players. Also, new smartphones can be designed to further expand the uses of mobile communications devices to new applications, such as unlocking doors, control of home automation products, monitoring and reporting vital signs, etc. These and other electronic devices often have different user control interfaces with different control keys or buttons, different control menus for various functions. The differences in the user control interfaces can make it difficult for some users to properly operate different devices and may create barriers or resistance in some consumers to new technologies and new devices. As more functions are integrated into one electronic device, the user control interfaces tend to become more complex and more different from one device to another, especially for devices from different manufacturers.

In addition, most electronic devices are designed for people without disabilities and thus may be difficult or even impossible for persons with certain disabilities to operate. For example, the trend toward miniaturization of mobile and other electronic devices has led to reduced sizes of input buttons and thus may present special challenges to users with disabilities.

### SUMMARY

This application describes, among others, techniques and devices for providing user interfaces for operating electronic devices in ways that can be customized to individual user's preferences. The techniques and devices described may be implemented to allow a customized user control interface, e.g., a set of customized control buttons, to control an electronic device with an original user control interface that is different from the customized user control interface. In operation, a control command of the customized user control interface is encoded according to a selected signal communication protocol and the encoded command is transmitted via a wireless or a wired communication link to an electronic device to be controlled, e.g., a cell phone or a game console. After being transmitted to and received by the device, the encoded command is converted by, e.g., a conversion software installed in the device, into an event code of the operating system of the device. This event code is then executed by the operating system of the device. In this process, the user uses the customized user control interface to operate the device without directly using the user control interface of the device. The customized user control interface can be configured according to the user's preferences and needs.

In one implementation, a method is described to provide a custom software driver in a programmable electronic device to convert a customized command to an event code of an operating system of the programmable electronic device to execute a corresponding function of the programmable electronic device, and to use a custom user interface device, which has a custom user interface different from a user interface of the programmable electronic device, to communicate the customized command from a user to the programmable electronic device. The communication between the custom user interface device and the programmable electronic device may be a wireless communication channel such as an IR or radio link or a wired communication wire such as a USB cable. The custom user interface device provides at least one customized user interface for a user to enter the customized command and a transmitter which generates a signal carrying the customized command.

In another implementation, a method for controlling a game console provides a custom software driver in a game console to convert a customized command to an event code of an operating system of the game console and to cause the operating system to execute a corresponding function of the game console; and to use a custom user interface device, which has a custom user interface different from a user interface of an original game controller for the game console, to transmit the customized command from a user to the game console.

These and other implementations are described in greater detail in the attached drawings, the detailed description and the claims.

### BRIEF DESCRIPTION OF DRAWINGS

FIG. 1 shows an example of a user interface device that is used to control a mobile phone.

FIGS. 2A and 2B illustrate operations of the microcontroller in the user interface device and the software deriver installed on the phone in FIG. 1.

FIGS. 3A and 3B illustrate exemplary implementations where a customized user interface device is used to control a game console that is equipped with a different original game controller.

### DETAILED DESCRIPTION

Implementations of the custom user interface mechanism for operating an electronic device can include a custom user interface that is customized and is different from the original user control interface of the electronic device, an encoding mechanism to encode a customer command into an encoded command according to a signal communication protocol, a transmitter to transmit to the electronic device a transmission signal that carries the encoded customer command, and a software driver installed in the electronic device to convert the customer command into an event code of the operating system of the electronic device and to cause the event code to be executed by the electronic device. As an example, a user may use the present techniques and devices to provide a custom means of activating phone input functions, such as through an external user joystick, completely different from the default user input mode in the electronic device. Hence, the user's operation of the mobile phone is no longer restricted to the default user interface of the mobile phone and can be adapted to suit the user's preference. In this example, the mobile phone is designed with capabilities for phone programming and interfacing by third-party developers so that the present techniques and devices can be used to provide the user-selected user input mode based on such capabilities of phone programming and interfacing by third-party developers. The software company Symbian, for example, provides the Symbian Operating System (OS) for mobile phones that offer open interfaces to allow developers to access to the phone's operating system and permit certain implementations of the present techniques and devices. See, e.g., Symbian SDK 2.0, Symbian consortium, at www.symbian.com. The present techniques and devices may also be implemented with systems other than Symbian OS.

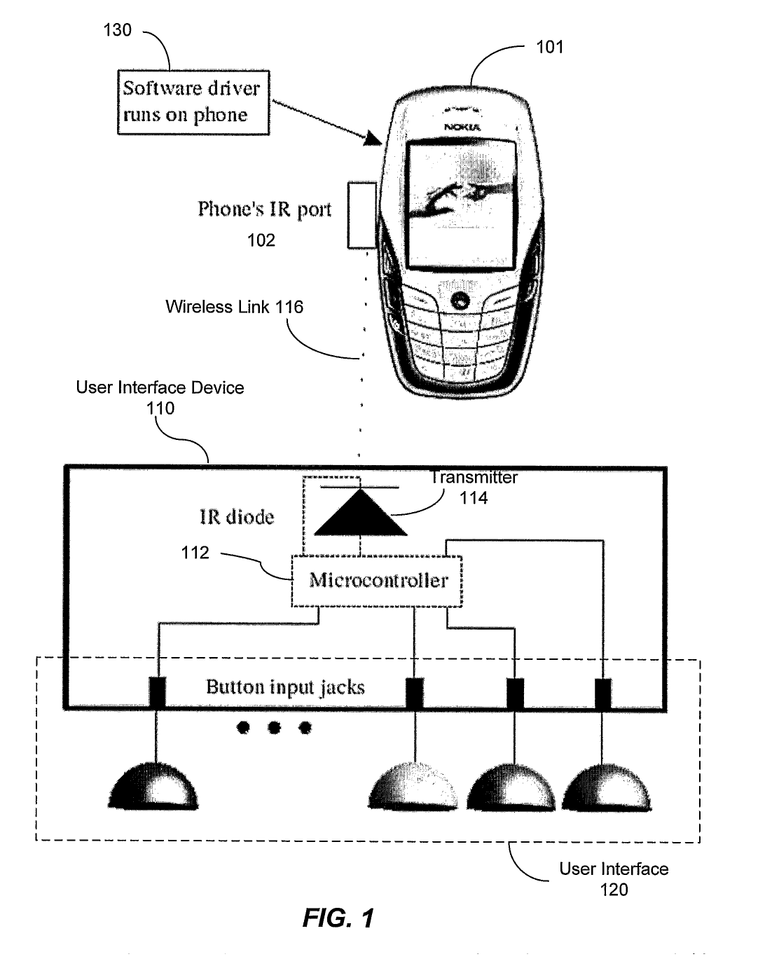

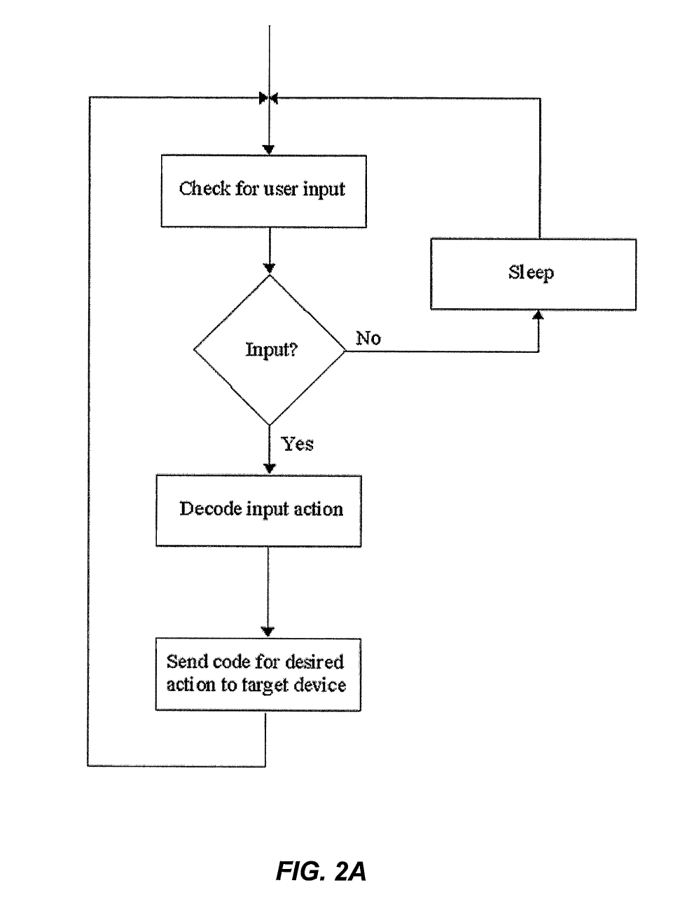

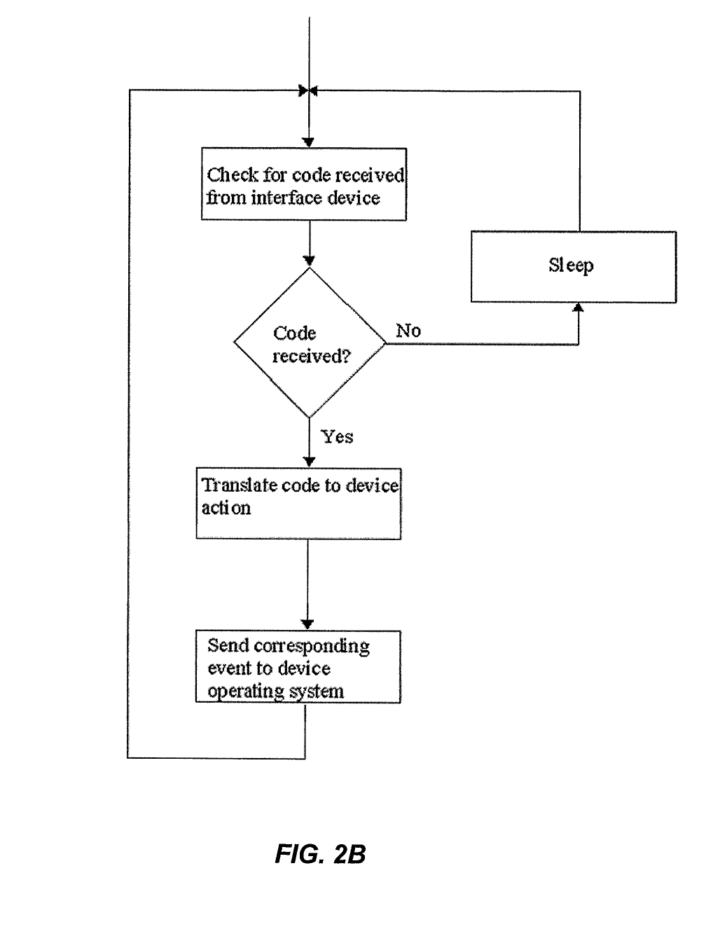

FIG. 1 illustrates one exemplary implementation of a custom user interface with a mobile phone 101 with a wireless communication port 102 such as an industrial, scientific and medical (ISM) radio (e.g., Bluetooth or Wi-Fi) port or an IR port. A user interface device 110 is provided to wirelessly communicate with the port 102 of the phone 101. Alternatively, the communication link may be a cable link such as an electrical cable where the port 102 is, for example a serial or USB port. A customized user interface 120 is implemented in the user interface device 110 so that a user can operate the phone 101 via the customized user interface 120 without directly using the original user interface in the mobile phone 101. A microcontroller 112 within the user interface device 110 is provided to convert custom user commands from the customized user interface 120 into control signals to drive a wireless transmitter 114 such as an IR diode (or Bluetooth chipset) as illustrated to send the commands via the wireless link 116 to the wireless port 102 of the phone 101. The micro controller 112 first encodes a customer command from the user into an encoded command according to a signal transmission protocol used the transmission between the transmitter 114 and the phone's IR port 102. FIG. 2A shows an example of the operation of the microcontroller 112. A customized software module or driver 130 designed for the user interface device 110 is installed in the phone 101 to operate with the phone operating system or the open portion of the phone operating system so that the customer commands from the user are converted into event codes of the phone 101 and are then executed by the phone 101. FIG. 2B shows an example of the operation of the driver 130. The phone 101 is used here as an example and may also be other electronic devices either with capabilities of programming and interfacing by third-party developers, or capable of being modified to accept alternative interfaces of the type presented herein.

As an example, the customized user interface 120 is illustrated as multiple customized buttons operated by the user. Alternatively, the customized user interface 120 may be implemented in other forms, such as a touch screen, a voice interface which receives voice input commands based on speech recognition, or a combination of two or more different input modes. In one implementation, the button-based user interface may be used to activate the voice recognition feature of the phone.

Examples for the device 101 in FIG. 1 include consumer electronic devices, such as phones, personal digital assistants (PDAs), and gaming consoles. In the phone category there are several platform types. Among programmable phones the major choices are those based on Java, BREW (Binary Runtime Environment for Wireless) which is an application development platform created by Qualcomm for CDMA-based mobile phones, and Symbian OS. Various java phones run their own proprietary operating systems in the background to ease programming by hiding OS details. The BREW solution provides a runtime environment for applications to run across a wide range of phones. The Symbian OS is a 32 bit, real-time operating system and is open in its architecture and application programming interfaces (APIs).

The user interface device 110 is a microcontroller based device. The button-based user interface 120 may include eight push button inputs and an infrared output. In the illustrated example, the inputs are jacks into which user-selectable buttons can be plugged. A joystick port enabling a standard joystick may be further included to complement the button array. The embedded program developed for the microcontroller 112 monitors the states of the array of input buttons. Upon detecting a button press, the user interface device 110 sends the corresponding infrared code to the phone using the IrDA protocol which is a standard for data transmission under Infrared Data Association. Implementations of the present system may use commodity hardware in the form of infrared LEDs and commodity microcontrollers to keep the cost low. This selection of hardware also permits power requirements to be kept to a minimum. The specific choices for the signal communications between the user interface device 110 and the phone 101 may be configured according to the specific needs and other considerations of the applications. As an example, the infrared link illustrated in FIG. 1 is a highly directional transmission technology and thus offers both less interference from other users and also greater security than other short range wireless technologies such as Bluetooth.

In the example where the phone 101 is based on a Symbia OS, the custom software driver 130 can be designed as a native Symbian OS application. In operation, the driver 130 monitors the infrared port 102 on the phone 101. Upon receiving a code, it determines the corresponding user input event (i.e. joystick left, main menu button press, etc). The driver 130 then determines the appropriate event code and forwards this to the OS. This combination of hardware and software permits complete control of all functions of a Symbian phone running the widely used Series 60 user interface for mobile phones. The software driver 130 may be designed to support the UIQ interface which is a pen-based graphical user interface for Symbian OS found on various phones.

The above example of the user interface mechanism can be used by a phone, accessory, or assistive device manufacturer to enable phone control by individuals with motor impairments. This includes those with developmental conditions such as cerebral palsy or autism, as well as those suffering from the effects of aging, such as arthritis. In order to enable more than the standard phone functionality, the installation of custom software coupled with supplementary hardware could enable many more mobile applications for users that support accessibility and independent living. For example, a mobile phone may be used to control door lock and home automation interfaces and the present custom user interface allows such functions to be accessible by person with disabilities. When implemented with a similar infrared code set to that used by existing commercial wireless IrDA keyboards, the present customized system may work out of the box with existing PDA keyboard drivers.

In addition to enabling control of mobile phones, PDAs and other hand-held devices, the present system may also be used for general control of a wide range of microprocessor-based electronic devices such as a desktop or laptop computer via button/switch access. In the absence of built-in infrared, an inexpensive IrDA USB dongle may be used. Also, depending on the control application being used on the host computer some software configuration (and possibly driver modification) may be required.

The user interface device 110 may be specifically designed to allow for cell phone access for people with motor impairments, in particular those who find it difficult or impossible to press the phone's numeric and menu buttons or operate the small joystick or arrow buttons commonly used in cellphone user interfaces. The user interface device 110 may be configured in different configurations to provide access for people with motor impairments. Voice command features based on voice recognition allow a motor impaired person to operate certain phone functions by simply speaking the commands in lieu of pressing buttons or operating the joystick. For example, instead of the key sequence “menu-button,” “right arrow,” “right arrow,” (to navigate to the “address book” application), and “joystick press” (to launch the address book application), the user would simply activate the voice command feature, and say “contacts” to launch the contacts application. The voice command implementation may be not suitable for some users. For example, the voice recognition system may not have adequate speech recognition capabilities in various situations such as dysarthric users or users with accents. As another example, the voice recognition configuration does not provide the level of privacy for some users. Also, many phones with voice command features require the user to press a button to activate the speech recognition and thus limit the accessibility of this feature to certain users with motor impairments. In addition, many phones with voice command features provide only a limited number of functions with voice commands. In particular, many new applications for downloads are typically not linked to voice commands. This can significantly limit the accessibility of various functions by users with motor impairments, such as control of lights, appliances, and door locks.

The user interface device 110 in FIG. 1 may be configured to provide an accessible button/joystick interface to allow users with motor impairments to operate the functions on the phone 101. In the example described below, the user interface 120 in the user interface device 110 is configured with large and accessible push buttons and joysticks for controlling the phone 101 with miniature control buttons and joysticks commonly used in many mobile phones, PDAs and other portable electronic devices today.

As a specific example, an 8-button user interface 120 was built as a prototype user interface device 110. Research indicates that eight push buttons are sufficient to activate most phone applications and functional features in mobile phones. Among the eight large buttons, four buttons are used to replace the 4 joystick directions. The 5th button is to replace the selection function (pressing the joystick/joypad). The 6th and 7th buttons are used replace the two soft-menu buttons which are present in a majority of cellphones. The 8th button is used to replace the menu button for accessing the application selection screen of a phone.

The prototype user interface device was designed without built-in buttons. Rather, the device had 8 input ports, to which a user can connect 8 buttons of their preference (large, small, different colors, etc.). When a particular button is pressed, the user interface device detects the press and converts the user command associated with the press action into an encoded code which is an 8-bit code. This code is then transmitted to the mobile phone via a selected transmission link (infrared, Bluetooth, cable, etc.) between the user interface device and the phone. Additional bits may be added to the encoded command depending on the transmission methodology used at the physical layer. The software driver for the user interface device installed on the phone receives the code, decodes the received code to determine which button function on the phone is requested by the user, and then sends the operating system an appropriate event code for the phone. Sending 8 bit codes for the eight control buttons used in the prototype user interface device is more than necessary, but it minimizes the probability of erroneous code reception. A full qwerty keyboard may have 104 buttons and thus 208 codes for controlling the buttons when two control codes are used for each button for releasing and pressing of the button. Consequently, using 8-bit codes allows for many more input functions to be used in alternative implementations of the present user interface mechanism.

As an example, consider the case when the user presses the left-arrow button of the eight buttons in the prototype device. The microcontroller in the user interface device detects this press, looks up the code for left-arrow press (which is 0x08 in hexadecimal notation), and then proceeds to send this code to the phone. In this example the IrDA protocol is used to send the code over the infrared at 9600 baud and the microcontroller is AT90S8515 controller. Consequently, the code is framed with the appropriate IrDA stop and stop bytes (0xc0 and 0xc1, respectively), so that the transmitted data is 0xc008c1. Start and stop bits are also added to each byte, so that 30 bits of data in total are transmitted to the phone. The 16-bit timer/counter of the AT90S8515 microcontroller is used to precisely control the timing of the bit intervals for flashing of the infrared LED at the proper rate required for 9600 baud.

The driver on the cellphone was written in C++ in the prototype user interface device but may be written in another high-level language. Referring to FIG. 2B, the driver sits in a loop monitoring the infrared port on the phone for received data. When the driver receives the bits sent from the microcontroller, the start and stop bits have already been stripped out by the lower layers of the phone's IrDA stack. Consequently, the driver sees just the 0x08. Upon receiving the bits, the driver searches for this code in an array of possible code values for the corresponding key event code of the phone. In this example, the event code EKeyLeftArrow in the Symbian Operating system for mobile phones corresponds to the pressing of the left-arrow button at the user interface device. Accordingly, the driver issues a system call to send this EKeyLeftArrow event code to the phone's operating system using the SimulateKeyEvent function. When the operating system receives the key code, the operating system executes an action depending on the currently selected phone feature. If the user is on the application menu, for example, the application icon to the left of the currently selected application is selected. However, if the user is in a multi-tab dialogue of an already activated application, then the tab to the left becomes active.

Using such a system of 8 buttons, many phone functions can be activated “as is” with nothing more running on the phone than the driver program. However, for some functionality, such as inputting numerical numbers, another custom software application may be used to facilitate the entry of numerical numbers. This custom software is installed on the phone to be controlled and generates an on-screen numeric keypad on the phone's display screen. In operation, this custom software allows the user to select numbers from the on-screen numeric keypad on the phone's screen. The user uses the 4 direction control buttons in the user interface device to move a selection cursor among the numbers, highlighting the desired number. The 5th button for the selection function is then pressed to select the desired number on the screen. By following this process repeatedly, the user is able to key in a phone number, and through a soft-menu button, to dial the phone number.

Because each numerical number on a phone keypad represents several letters, the user can also input text in the same manner, and the application can also send text messages. Another function of the software, is to display an on-screen qwerty keyboard. In a manner similar to inputting numerical numbers, the user is also able to input text directly, i.e., instead of pressing the “7” button four times for the letter “s”, the user can move the selection field once down and once right to access the letter “s” on the qwerty keyboard. Alternate keyboard layouts are possible, half-keyboards, or even an elimination selection model of letter selection. In this last case, the user “eliminates” certain sections of the keyboard repeatedly, until the smaller area containing the desired letter is present. Again with the letter “s” example, the user selects “up” to highlight the “a” row of the keyboard. Then the select ‘left’ to indicate the desired letter is one of {“a,” “s,” “d,” “f”}, finally the user selects “up” to indicate it is the second of the remaining options. Such alternative text input interfaces are easily implemented in software on the phone.

The above implementations of the custom user interface may be configured to allow a user to use a customized user interface device to control an electronic device with a different user control interface. For example, different electronic game consoles may have different game controllers. Some game players may prefer certain customized game control interface arrangements that are different from a particular game control interface provided by the game console manufacturer. When the operating system of a game console allows for access by a third party software driver like the software driver 130 in the example in FIG. 1 to be installed and run on the game console operating system, a game player can use a customized user interface device to control the game console.

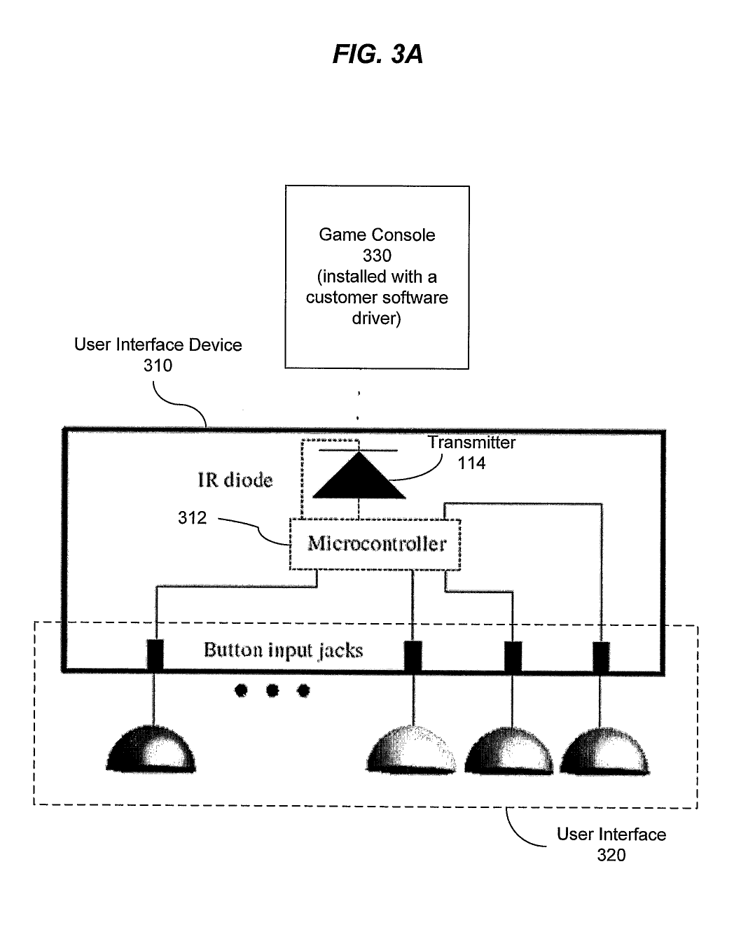

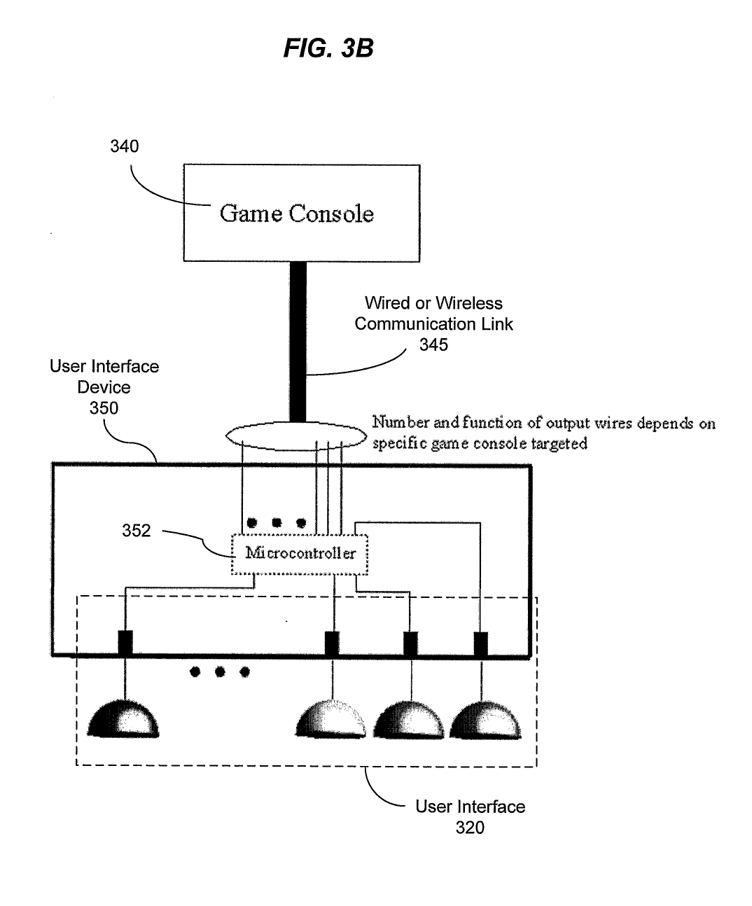

FIG. 3A illustrates an example where a customized user interface device 310 with a customized user interface 320 (e.g., with control buttons and joysticks) is used to control a game console 330 that is equipped with a different original game controller. A microcontroller 312 is provided in the device 310 to encode the commands from the user interface 320 into encoded commands to transmit to the game console 330 by the transmitter 114. A custom software driver installed in the game console 330 converts the received command into an event code of the operating system of the game console 330 and the event code is then executed by the operating system. With proper software drivers, the user may use the same customize user interface device 310 as the game controller to control different game consoles.

The customized user interface design in FIG. 3A requires installation of a software driver in the game console and access to the operating system of the game console. FIG. 3B shows another implementation without the software driver. A user interface device 350 is provided to directly communicate with the game console 340 using the original communication port via a communication link 345 which may be a wired cable or a wireless link depending on the design of the game console 340. A microprocessor 352 is provided in the user interface device 350 to convert a command from the customized user interface 320 into a game console command executable by the game console 340. Therefore, although the user interface device 350 is different from the original game controller for the game console 340 and the customized user interface 320 is different from the user interface in the original game controller, the commands sent from the user interface device 350 are formatted as if they were generated from the original game controller. In this design, the game console 340 remains unchanged in its software and hardware.

Only a few examples are described. Other variations and enhancements may be made based on what is described here.

What is claimed is:

1. A method, comprising:
providing a custom software driver in a programmable electronic device to convert a customized command to an event code of an operating system of the programmable electronic device to execute a corresponding function of the programmable electronic device; and
using a custom user interface device, which has a custom user interface different from a user interface of the programmable electronic device, to communicate the customized command from a user to the programmable electronic device, wherein the user interface device provides at least one customized user interface for a user to enter the customized command and a transmitter which generates a transmission signal carrying the customized command.

2. The method as in claim 1, wherein the programmable electronic device is a mobile phone based on the Symbian operating system.

3. The method as in claim 1, wherein the programmable electronic device is a mobile phone based on an operating system different from the Symbian operating system.

4. The method as in claim 1, wherein the programmable electronic device is a personal digital assistant (PDA) electronic device.

5. The method as in claim 1, wherein the programmable electronic device is a portable computer.

6. The method as in claim 1, wherein the programmable electronic device is a game console equipped with a game controller different from the custom user interface device.

7. The method as in claim 1, wherein the one customized user interface includes control buttons.

8. The method as in claim 1, wherein the one customized user interface includes a voice input interface.

9. The method as in claim 8, wherein the one customized user interface includes a voice input interface, and the user interface device further comprises a second customized user interface with control buttons.

10. The method as in claim 1, wherein the transmitter in the user interface device includes an IR diode to wirelessly transmit the customized command.

11. The method as in claim 1, wherein the transmitter in the user interface device includes a radio transmitter to wirelessly transmit the customized command.

12. The method as in claim 1, wherein the wireless receiver port in the electronic device is an IrDA USB dongle.

13. The method as in claim 1, wherein the programmable electronic device is a mobile phone based on a BREW (Binary Runtime Environment for Wireless) operating system.

14. The method as in claim 1, wherein the programmable electronic device is a Java-enabled mobile phone.

15. The method as in claim 1, wherein the transmitter in the user interface device is operable to transmit the customized command via a cable connected between the user interface device and the programmable electronic device.

16. A method for controlling a game console, comprising:
providing a custom software driver in a game console to convert a customized command to an event code of an operating system of the game console and to cause the operating system to execute a corresponding function of the game console; and
using a custom user interface device, which has a custom user interface different from a user interface of an original game controller for the game console, to transmit the customized command from a user to the game console.

17. The method as in claim 16, further comprising:
encoding the customized command into an encoded signal according to a transmission signal protocol for transmission between the game console and the custom user interface device; and
transmitting the encoded signal to the game console.

18. A method for controlling a game console, comprising:
providing a customized user interface device, which has a customized user interface different from a user interface of an original game controller for the game console, to allow a user to enter commands for controlling the game console;
providing a mechanism inside the customized user interface device to convert an entered command from the customized user interface into a command executable by of an operating system of the game console; and
providing a mechanism to transmit the converted command from the customized user interface device to the game console to be executed by the game console.

19. A customized user interface device, comprising:
a user input interface comprising a plurality of control button input jacks configured to accept control buttons for controlling the operation of a separate electronic device having a different user input interface;
a microcontroller to encode an user input into an encoded signal according to a communication protocol for signal transmission to the electronic device; and
a signal transmitter to generate a transmission signal that carries the encoded signal.
